(19) United States
(12) Patent Application Publication
(10) Pub. No.: US 2024/0119113 A1
(43) Pub. Date: Apr. 11, 2024

(54) FAULT DETECTION METHOD FOR ROTATING MACHINE BASED ON SPARSE TIME SYNCHRONOUS AVERAGING

(71) Applicant: XI’AN JIAOTONG UNIVERSITY, Xi'an (CN)

(72) Inventors: Shibin WANG, Xi'an (CN); Jianghan ZHOU, Xi'an (CN); Xuefeng CHEN, Xi'an (CN); Zhibin ZHAO, Xi'an (CN); Baoqing DING, Xi'an (CN); Chuang SUN, Xi'an (CN)

(21) Appl. No.: 18/144,053

(22) Filed: May 5, 2023

(30) Foreign Application Priority Data
Sep. 13, 2022 (CN) 2022111125058

(51) Int. Cl. G06F 17/16; G01M 13/045; G06F 17/14; G06F 17/18

(52) U.S. Cl. CPC G06F 17/16; G01M 13/045; G06F 17/142; G06F 17/18

(57) ABSTRACT

A fault detection method for a rotating machine based on sparse time synchronous averaging is disclosed, and the method includes: collecting a vibration signal and a rotating frequency or rotating frequency pulse signal of the rotating machine and performing analog-to-digital conversion to obtain the vibration signal and rotating speed information by a sensor; according to the type and number of detection components in the rotating machine, constructing a component-aware comb vector g based on the vibration signal and rotating speed information, wherein the type includes the gear, rotor and bearing; constructing a quasi-time synchronous average vector w based on the component-aware comb vector g; constructing a sparse time synchronous averaging model F by using the quasi-time synchronous average vector w; solving the sparse time synchronous averaging model F with an optimization solution algorithm to obtain a sparse spectrum and a reconstruction time signal.

### CROSS-REFERENCE TO RELATED APPLICATION

This application claims priority from the Chinese patent application 2022111125058 filed Sep. 13, 2022, the content of which is incorporated herein in the entirety by reference.

### TECHNICAL FIELD

The present disclosure relates to the technical field of rotating machine fault diagnosis, in particular a fault detection method for a rotating machine based on sparse time synchronous averaging.

### BACKGROUND

In the fault diagnosis of various rotating machines, due to the complex structure of system components, many transmission components, strong external interference, and long distance between measuring points and other reasons, the noise in the vibration signal is often large, while there is interference from various complex frequency components, and the fault feature frequency concerned is often submerged. The time synchronous averaging method is an effective means to extract periodic components, filter clutter and improve the signal-to-noise ratio. The algorithm is simple and effective, with fast calculation speed, and has been widely used in various scenes. However, the common time synchronous averaging method has poor performance against rotating frequency fluctuations, and has the problems that the signal length required for superposition is long and only the same frequency component can be extracted at the same time. Therefore, it is necessary to improve or propose a new algorithm to replace the traditional time synchronous averaging method so as to extract the fault feature components efficiently.

The above information disclosed in the background is only used to enhance the understanding of the background of the disclosure, so it may contain information that does not constitute the prior art known to those skilled in the field in the country.

### SUMMARY

In view of the problems existing in the prior art, the present disclosure proposes a fault detection method for a rotating machine based on sparse time synchronous averaging, which uses the rotating frequency information of components to construct an appropriate sparse weighting matrix, uses sparse time synchronous averaging to obtain the sparse frequency spectrum of the vibration signal, and then constructs the STSA_CI index calculation method based on the sparse frequency spectrum and its reconstructed time signal, and judges whether the fault occurs according to the change trend of the index.

The objective of the present disclosure is achieved by the following solutions, and the fault detection method for a rotating machine based on sparse time synchronous averaging includes:
S100, collecting a vibration signal and a rotating frequency or rotating frequency pulse signal of the rotating machine and performing analog-to-digital conversion to obtain the vibration signal and rotating speed information by a sensor;
S200, according to the type and number of detection components in the rotating machine, constructing a component-aware comb vector g based on the vibration signal and rotating speed information, wherein the type includes the gear, rotor and bearing;
S300, constructing a quasi-time synchronous average vector w based on the component-aware comb vector g;
S400, constructing a sparse time synchronous averaging model F by using the quasi-time synchronous average vector w;
S500, solving the sparse time synchronous averaging model F with an optimization solution algorithm to obtain a sparse spectrum and a reconstruction time signal; and
S600, constructing an STSA_CI index according to the sparse spectrum and time signal for fault diagnosis, wherein, for a gear fault, the STSA_CI index includes a root mean square value STSA_RMS, a crest factor STSA_CF, a kurtosis index STSA_KurV, an engaging frequency amplitude STSA_OMX, a feature frequency amplitude STSA_FQ and an envelope kurtosis index STSA_NB4; for a rotor fault, the STSA_CI index includes a rotating frequency amplitude STSA_AR, a root mean square value STSA_RMS, an average amplitude STSA_MA and a square root amplitude STSA_RA, and for a bearing fault, the STSA_CI index includes a feature frequency amplitude STSA_FQ, a crest factor STSA_CF or a kurtosis index STSA_KurV.

It should be noted that in the fault detection method for a rotating machine based on sparse time synchronous averaging that appears hereinafter,
in S200, 1) for the case where the detection component is one gear, the component-aware comb vector g of the gear is obtained by the following equation:

$$g = b * {\sum }_{k ∈ N} \cdot δ ( n - ⌊ \frac{kM ω}{60 {F}_{s}} ⌋ ) ,$$

wherein M is a sparse representation coefficient length, k represents an order of a frequency component, ω is the rotating speed of the gear, Fₛ is the sampling frequency, └⋅┘ is the rounding operation, N* represents the positive integer set, δ is a function of n, a return value is a Boolean vector, and an expression is as follows:

$$δ ( n - k ) = \{ \begin{matrix}1 , & n = k , n ∈ ℤ ; \\ 0 , & n \neq k , n ∈ ℤ ;\end{matrix}$$

wherein, Σ(⋅) represents a successive logical OR operation, [symbol] represents an integer, “*” is a convolution operation of the Boolean vector, which is defined as:

y(n)=x(n)*h(n)=Σ_{i=-∞}^{∞}x(i)&h(n−i),
wherein, & is a logical AND operation, b is a sequence of filter passbands and is a Boolean vector with a dimension of h, whose physical meaning is the bandwidth of a filter passband in the sense of the number of data points, and the expression of b is:

b(n)=1, n∈1, 2, . . . , h;
2) for the case where the detection components are two gears, the component-aware comb vectors g of the gears are obtained by:

$${g}_{c 1} = b * {\sum }_{k ∈ N} \cdot δ ( n - ⌊ \frac{kM {ω}_{1}}{60 {F}_{s}} ⌋ ) ,$$

$${g}_{c 2} = b * {\sum }_{k ∈ N} \cdot δ ( n - ⌊ \frac{kM {ω}_{2}}{60 {F}_{s}} ⌋ ) ,$$

$$g = {g}_{c 1} \vert {g}_{c2} ,$$

wherein ω₁, ω₂ are the rotating speeds of the two gears; g_{c1}, g_{c2} are the component-aware comb vectors of the gear 1 and gear 2, respectively, g is a global component-aware comb vector, “|” is a Boolean logical OR operation; and
3) for the case where the detection components are three and more gears, the component-aware comb vector g is obtained by the following equation:

$$g = b * {\sum }_{i = 1}^{p} {\sum }_{k ∈ N} \cdot δ ( n - ⌊ \frac{kM {ω}_{i}}{60 {F}_{s}} ⌋ ) ,$$

wherein the variable pin the equation is the number of concerned gears and ωᵢ is the rotating speed of each gear.

In the fault detection method for a rotating machine based on sparse time synchronous averaging,
in S200, 1) for the case where the detection component is one rotor, the component-aware comb vector g of the rotor is obtained by the following equation:

$$g = b * {\sum }_{k ∈ N} \cdot δ ( n - ⌊ \frac{kM ω}{60 {F}_{s}} ⌋ ) ,$$

wherein, in this equation, ω is the rotating speed of the rotor, k represents an order of a frequency component, M is a sparse representation coefficient length, Fₛ is the sampling frequency, └⋅┘ is the rounding operation, N* represents the positive integer set, δ is a function of n, a return value is a Boolean vector, and an expression is as follows:

$$δ ( n - k ) = \{ \begin{matrix}1 , & n = k , n ∈ ℤ ; \\ 0 , & n \neq k , n ∈ ℤ ;\end{matrix}$$

wherein, Σ(⋅) represents a successive logical OR operation, [symbol] represents an integer, “*” is a convolution operation of the Boolean vector, which is defined as:

y(n)=x(n)*h(n)=Σ_{i=-∞}^{∞}x(i)&h(n−i),
wherein, & is a logical AND operation, b is a sequence of filter passbands and is a Boolean vector with a dimension of h, whose physical meaning is the bandwidth of a filter passband in the sense of the number of data points, and the expression of b is:

b(n)=1, n∈1, 2, . . . , h;
2) for the case where the detection components are two rotors, the component-aware comb vectors g of the rotors are obtained by the following equations:

$${g}_{r 1} = b * {\sum }_{k = 1}^{3} δ ( n - ⌊ \frac{kM {ω}_{1}}{60 {F}_{s}} ⌋ ) ,$$

$${g}_{r 2} = b * {\sum }_{k = 1}^{3} δ ( n - ⌊ \frac{kM {ω}_{2}}{60 {F}_{s}} ⌋ ) ,$$

$${g}_{r 3} = b * {\sum }_{l = 1}^{3} {\sum }_{k = 1}^{3} δ ( n - ⌊ \frac{M ( k {ω}_{2} + l {ω}_{1} )}{60 {F}_{s}} ⌋ ) ,$$

$${g}_{r 4} = b * {\sum }_{l = 1}^{3} {\sum }_{k = 1}^{3} δ ( n - ⌊ \frac{M \vert k {ω}_{2} + l {ω}_{1} \vert}{60 {F}_{s}} ⌋ ) ,$$

$$g = {\sum }_{k = 1}^{4} {g}_{rk} ,$$

wherein ω₁, ω₂ are the rotating speeds of the two rotors; gᵣ₁ represents the component-aware comb vector of the rotating frequency of the rotor 1, gᵣ₂ represents the component-aware comb vector of the rotating frequency of the rotor 2, gᵣ₃ represents the component-aware comb vector of each of various sum frequencies of the rotor 1 and rotor 2, gᵣ₄ represents the component-aware comb vector of each of various difference frequencies of the rotor 1 and rotor 2, and g is a global component-aware comb vector; and
3) for the case where the detection components are three rotors, the component-aware comb vectors g of the rotors are obtained by the following equations:

$${g}_{r 1} = b * {\sum }_{k = 1}^{3} δ ( n - ⌊ \frac{kM {ω}_{1}}{60 {F}_{s}} ⌋ ) ,$$

$${g}_{r 2} = b * {\sum }_{k = 1}^{3} δ ( n - ⌊ \frac{kM {ω}_{2}}{60 {F}_{s}} ⌋ ) ,$$

$${g}_{r 3} = b * {\sum }_{k = 1}^{3} δ ( n - ⌊ \frac{kM {ω}_{3}}{60 {F}_{s}} ⌋ ) ,$$

$$g = {\sum }_{k = 1}^{3} {g}_{rk} ,$$

wherein ω₁, ω₂, ω₃ are the rotating speeds of the three rotors, respectively, and gᵣ₁, gᵣ₂, gᵣ₃ represent the component-aware comb vectors of the 3 rotors, and g is a global component-aware comb vector.

In the fault detection method for a rotating machine based on sparse time synchronous averaging,
in S200, for the case where the detection component is a bearing, the component-aware comb vector g of the bearing is obtained by the following equation:

$$g = ∼ ( b * {\sum }_{i = 1}^{p} {\sum }_{k ∈ {N}^{*}} δ ( n - ⌊ \frac{kM {ω}_{i}}{60 {F}_{s}} ⌋ ) ) ,$$

wherein, in this equation, ωᵢ is the rotating speed of the gear or rotor when the signal is introduced with interference, k represents an order of a frequency component, N* represents the positive integer set, p is the total number of the gears or rotors when the signal is introduced with interference, ˜ is a logical NOT operation, M is a sparse representation coefficient length, Fₛ is the sampling frequency, └⋅┘ is the rounding operation, δ is a function of n, a return value is a Boolean vector, and an expression is as follows:

$$δ ( n - k ) = \{ \begin{matrix}1 , & n = k , n ∈ ℤ ; \\ 0 , & n \neq k , n ∈ ℤ ;\end{matrix}$$

wherein, Σ(⋅) represents a successive logical OR operation, “*” is a convolution operation of the Boolean vector, which is defined as:

y(n)=x(n)*h(n)=Σ_{i=-∞}^{∞}x(i)&h(n−i)
wherein, & is a logical AND operation, b is a sequence of filter passbands and is a Boolean vector with a dimension of h, whose physical meaning is the bandwidth of a filter passband in the sense of the number of data points, and the expression of b is:

b(n)=1, n∈1, 2, . . . , h.

In the fault detection method for a rotating machine based on sparse time synchronous averaging,
in S300, the component-aware comb vector g generates the quasi-time synchronous average vector w according to the following steps:

w′(n)=i−ηg,

w=w′(1:M),
wherein w′ is a quasi-time synchronous average vector distributed over an entire positive integer domain, and w′ is truncated to obtain a quasi-time synchronous average vector w of the length A, η is a passband amplitude factor, which is multiplied with the component-aware comb vector g to obtain a real number; i is a vector with a dimension of M and all values of 1, M is the sparse representation coefficient length; and
it is noted that although p [symbol] ω and w appeared above have different definitions and forms in different algorithm application objects, their mathematical meanings and dimensions are the same when they are applied to a sparse model. For the sake of simplicity, the disclosure no longer distinguishes the different forms of these variables in each application object of the algorithm.

In the fault detection method for a rotating machine based on sparse time synchronous averaging,
in S400, constructing the sparse time synchronous averaging model F by using the quasi-time synchronous average vector w is as follows:

$$arg {min}_{x} {‖ y - Ax ‖}_{2}^{2} + λ ‖ w ∘ x ‖ ,$$

wherein y is a noise-contained signal to be analyzed, A is a linear transformation operator, x is a sparse representation coefficient, “∘” is a vector dot product operator, λ is a regularization parameter, w is the quasi-time synchronous average vector, and when the linear transformation operator A is the Fourier transform, it is required to perform an axisymmetric operation on w:

$$w ( \frac{M + 2}{2} : 1 : M ) = w ( \frac{M}{2} : - 1 : 1 ) .$$

In the fault detection method for a rotating machine based on sparse time synchronous averaging,
S500 includes,
S501, first, performing following iterative steps on the sparse time synchronous averaging model, setting an iteration constant μ to satisfy 0<μ<1, setting an initial sparse representation coefficient x₀ and an iterative intermediate variable z₀ to be arbitrary M-dimensional column vectors, setting a maximum number of loops to be Nit in the range of 20<Nit<10000, marking a loop variable as k, setting a loop termination constant ε to be 10⁻⁶; and taking an initial value t₀ of an iteration variable tₖ as 1;
S502, operating an intermediate variable zₖ using a soft threshold function soft,

xₖ=soft(zₖ−μA^{T}(Azₖ−y), μwλ),
wherein, the soft threshold function soft is expressed as follows:

$$soft ( x , T ) = x \cdot max ( 1 - \frac{T}{\vert x \vert} , 0 ) ,$$

A is a linear transformation operator, w is a quasi-time synchronous average vector, and λ is a regularization parameter;
S503, updating the variable tₖ, such that

$${t}_{k + 1} = \frac{1 + \sqrt{1 + 4 {t}_{k}^{2}}}{2} ;$$

S504, updating zₖ using the xₖ results of the first two iterations:

$${z}_{k + 1} = {x}_{k} + ( \frac{{t}_{k} - 1}{{t}_{k + 1}} ) ( {x}_{k} - {x}_{k - 1} ) ;$$

and
S505, increasing the loop variable k by one, if k>Nit or ∥yₖ−Axₖ∥₂²+λ∥w∘xₖ∥−∥yₖ₋₁−Axₖ₋₁∥₂²−λ∥w∘xₖ₋₁∥<ε is satisfied, then setting \hat{x}=xₖ₋₁, ŷ=A\hat{x},
to obtain a time signal ŷ and a sparse representation coefficient \hat{x} subjected to sparse time synchronous averaging, and exiting the loop, otherwise returning to S502.

In the fault detection method for a rotating machine based on sparse time synchronous averaging,
the STSA_CI index is composed of the following indices for a gear fault:
1) a root-mean-square value STSA_RMS:

$$STSA\_RMS = \sqrt{\frac{1}{N} {\sum }_{n = 1}^{N} {\hat{y}}^{2} ( n )} ,$$

wherein ŷ represents a time signal subjected to sparse time synchronous averaging, and N is the signal length;
2) a crest factor STSA_CF:

$$STSA\_CF = \frac{{\hat{y}}_{max}}{STSA\_RMS} ;$$

wherein ŷₘₐₓ is the maximum absolute value of in a ŷ sequence, and is calculated by the method of loop traversal,
3) a kurtosis index STSA_KurV:

$$STSA\_KurV = \frac{N {{\sum }_{n = 1}^{N} [ \hat{y} ( n ) - \overline{y} ]}^{4}}{{\{ {{\sum }_{n = 1}^{N} [ \hat{y} ( n ) - \overline{y} ]}^{2} \}}^{2}} ;$$

wherein y̅ is the average value of the ŷ sequence,
4) an engaging frequency amplitude STSA_OMX:

STSA_OMXᵢⱼ=Aᵢⱼ;
wherein Aᵢⱼ represents the amplitude of the j-th-order engaging frequency of the i-th gear in the sparse representation coefficient \hat{x} subjected to sparse time synchronous averaging,
5) a feature frequency magnitude STSA_FQ:

STSA_FQᵢ=Σⱼ₌₁³Bᵢⱼ
wherein Bᵢⱼ represents the amplitude of the j-th-order fault feature frequency of the i-th gear in the envelope spectrum φ, while the envelope spectrum is obtained by the following steps:

h={square root over (\hat{y}²+(H(ŷ))²)},

φ= [symbol] (h),
wherein H(⋅) represents the Hilbert transform, [symbol] (⋅) represents the discrete Fourier transform; and
6) an envelope kurtosis index STSA_NB4:

$$STSA\_NB4 = \frac{N {\sum }_{n = 1}^{N} {( {h}_{l} ( n ) - {\overline{h}}_{l} )}^{4}}{{\{ \frac{1}{L} {\sum }_{l = 1}^{L} [ {\sum }_{n = 1}^{N} {( {h}_{l} ( n ) - {\overline{h}}_{l} )}^{2} ] \}}^{2}} ;$$

wherein l represents the number of segments of the present data record in the multi-segment data record, L is the total number of segments of the data record, hₗ is the envelope of the time signal of the l-th data subjected to sparse time synchronous averaging, and h̅ₗ is the average of hₗ.

In the fault detection method for a rotating machine based on sparse time synchronous averaging, the STSA_CI index is composed of the following indices for a gear fault and a rotor fault:
1) a rotating frequency amplitude STSA_AR, in the equation, A_{R}_{ᵢⱼ} represents the amplitude of the j-th multiple frequency of the i-th rotor in the sparse representation coefficient \hat{x} subjected to sparse time synchronous averaging:

STSA_AR=A_{R}_{ᵢⱼ};
2) a root-mean-square value STSA_RMS:

$$STSA\_RMS = \sqrt{\frac{1}{N} {\sum }_{n = 1}^{N} {\hat{y}}^{2} ( n )} ,$$

wherein ŷ represents a time signal subjected to sparse time synchronous averaging, and N is the signal length;
3) an average amplitude STSA_MA:

$$STSA\_MA = \frac{1}{N} {\sum }_{n = 1}^{N} \vert \hat{y} ( n ) \vert ;$$

and
4) a square root amplitude STSA_RA:

$$STSA\_RA = {[ \frac{1}{N} {\sum }_{n = 1}^{N} \sqrt{\vert \hat{y} ( n ) \vert} ]}^{2} .$$

In the fault detection method for a rotating machine based on sparse time synchronous averaging, the STSA_CI index is composed of the following indices for a bearing fault:
1) a feature frequency magnitude STSA_FQ:

STSA_FQᵢ=Σⱼ₌₁³Aᵢⱼ,
wherein Aᵢⱼ represents the amplitude of the j-th-order frequency of the i-th bearing fault feature frequency in the envelope spectrum φ, while the envelope spectrum is obtained by:

h={square root over (\hat{y}²+(H(ŷ))²)}

φ= [symbol] (h)
wherein ŷ is a time signal subjected to sparse time synchronous averaging, H(⋅) represents the Hilbert transform, and [symbol] (⋅) represents the discrete Fourier transform;
2) a crest factor STSA_CF:

$$STSA\_CF = \frac{{\hat{y}}_{max}}{\sqrt{\frac{1}{N} {\sum }_{n = 1}^{N} {\hat{y}}^{2} ( n )}} ,$$

wherein N is the signal length; and
3) a kurtosis STSA_KurV:

$$STSA\_KurV = \frac{N {{\sum }_{n = 1}^{N} [ \hat{y} ( n ) - \overline{y} ]}^{4}}{{\{ {{\sum }_{n = 1}^{N} [ \hat{y} ( n ) - \overline{y} ]}^{2} \}}^{2}} .$$

Compared with the prior art, the disclosure has the following advantages: in the fault detection method for a rotating machine based on sparse time synchronous averaging, a sensor collects a vibration signal and a rotating frequency or rotating frequency pulse signal of the rotating machine and performs analog-to-digital conversion to obtain the vibration signal and rotating speed information; according to the type and number of detection components in the rotating machine, a component-aware comb vector g is constructed based on the vibration signal and rotating speed information; a quasi-time synchronous average vector w is constructed based on the component-aware comb vector g; a sparse time synchronous averaging model F is constructed by using the quasi-time synchronous average vector w; the sparse time synchronous averaging model F is solved with an optimization solution algorithm to obtain a sparse spectrum \hat{x} and a reconstruction time signal ŷ; and finally, according to the corresponding component STSA_CI index, fault diagnosis is performed, and the diagnostic accuracy is significantly improved.

### BRIEF DESCRIPTION OF THE DRAWINGS

By reading the detailed description in the preferred specific embodiments below, various other advantages and benefits of the disclosure will become clear to those skilled in the art. The drawings of the specification are only for the purpose of showing preferred embodiments, and are not considered as a limitation of the disclosure. Obviously, the drawings described below are just some embodiments of the disclosure. For those skilled in the art, other drawings can be obtained from these drawings without any creative effort, and throughout the drawings, the same components are denoted by the same reference signs.

In the attached drawings:

FIG. 1 is a flow chart of a gear mechanical fault detection method based on sparse time synchronous averaging proposed by the disclosure;

FIG. 2a is an original time waveform diagram of a faulty gear signal;

FIG. 2b is an original Fourier transform spectrum of the faulty gear signal;

FIG. 2c is a sparse spectrum diagram of the faulty gear signal subjected to sparse time synchronous averaging;

FIG. 2d is a waveform diagram of a time reconstruction signal of the faulty gear signal subjected to sparse time synchronous averaging;

FIG. 2e is an envelope spectrum of the time reconstruction signal of the faulty gear signal subjected to sparse time synchronous averaging;

FIG. 3a is an original time waveform diagram of a normal gear signal;

FIG. 3b is an original Fourier transform spectrum diagram of the normal gear signal;

FIG. 3c is a sparse spectrum diagram of the normal gear signal subjected to sparse time synchronous averaging;

FIG. 3d is a waveform diagram of a time reconstruction signal of the normal gear signal subjected to sparse time synchronous averaging;

FIG. 3e is an envelope spectrum of the time reconstruction signal of the normal gear signal subjected to sparse time synchronous averaging;

FIG. 4a is an original time waveform diagram of a normal rotor signal;

FIG. 4b is a Fourier transform spectrum of a normal rotor vibration signal;

FIG. 4c is a sparse spectrum diagram of the normal rotor vibration signal subjected to sparse time synchronous averaging;

FIG. 4d is a waveform diagram of the time reconstruction signal of the normal rotor signal subjected to sparse time synchronous averaging;

FIG. 5a is an original time waveform diagram of a faulty rotor signal;

FIG. 5b is a Fourier transform spectrum of a faulty rotor vibration signal;

FIG. 5c is a sparse spectrum diagram of the faulty rotor vibration signal subjected to sparse time synchronous averaging;

FIG. 5d is a waveform diagram of the time reconstruction signal of the normal rotor signal subjected to sparse time synchronous averaging;

FIG. 6a is an original time waveform diagram of a faulty bearing signal;

FIG. 6b is a Fourier transform spectrum of a faulty bearing vibration signal;

FIG. 6c is a sparse spectrum diagram of the faulty bearing vibration signal subjected to sparse time synchronous averaging;

FIG. 6d is a waveform diagram of the time reconstruction signal of the faulty bearing signal subjected to sparse time synchronous averaging;

FIG. 6e is an envelope spectrum of a time reconstruction signal of the faulty bearing vibration signal subjected to sparse time synchronous averaging;

FIG. 7a is an original time waveform diagram of a normal bearing signal;

FIG. 7b is a Fourier transform spectrum of a normal bearing vibration signal;

FIG. 7c is a sparse spectrum diagram of the normal bearing vibration signal subjected to sparse time synchronous averaging;

FIG. 7d is a waveform diagram of a time reconstruction signal of the faulty bearing signal subjected to sparse time synchronous averaging; and

FIG. 7e is an envelope spectrum of a time reconstruction signal of the normal bearing vibration signal subjected to sparse time synchronous averaging.

The disclosure is further explained below in combination with the drawings and embodiments.

### DETAILED DESCRIPTION OF THE EMBODIMENTS

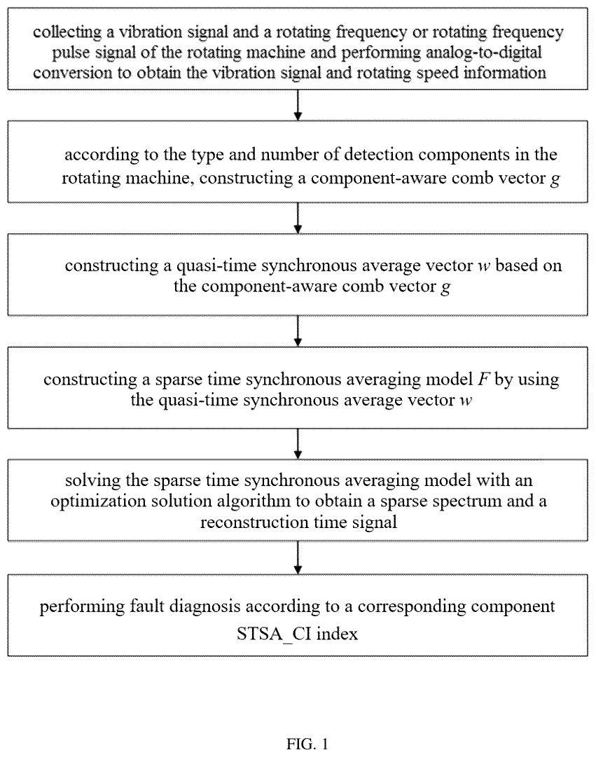

Specific embodiments of the disclosure will be described in more detail below with reference to FIG. 1 to FIG. 7e. Although specific embodiments of the disclosure are shown in the accompanying drawings, it should be understood that the disclosure can be implemented in various forms and should not be limited by the embodiments described herein. On the contrary, these embodiments are provided to enable a more thorough understanding of the disclosure, and to fully convey the scope of the disclosure to those skilled in the art.

It should be noted that certain terms are used in the specification and claims to refer to specific assemblies. Those skilled in the art should understand that they may use different nouns to address the same assembly. The specification and claims do not use the difference of nouns as the way to distinguish assemblies, but use the difference of functions of assemblies as the criterion. If “including” or “comprising” mentioned in the entire description and claims is an open term, it should be interpreted as “including but not limited to”. The later description in the specification is preferred implementations to implement the disclosure. However, the description is for the purpose of the general principles of the specification and is not intended to limit the scope of the disclosure. The scope of protection of the disclosure shall be subject to those defined in the appended claims.

In order to facilitate the understanding of the embodiments of the disclosure, the following will further explain the specific embodiments in combination with the drawings, and each drawing does not constitute a limitation to the embodiments of the present disclosure.

FIG. 1 is a flow chart of a fault detection method for a rotating machine based on sparse time synchronous averaging proposed by the disclosure, and the method includes:
step 1, a sensor collects a vibration signal and a rotating frequency or rotating frequency pulse signal of the rotating machine and performs analog-to-digital conversion to obtain the vibration signal and rotating speed information;
step 2, according to the type and number of detection components in the rotating machine, a component-aware comb vector g is constructed;
step 3, a quasi-time synchronous average vector w is constructed based on the component-aware comb vector g;
step 4, a sparse time synchronous averaging model F is constructed by using the quasi-time synchronous average vector w;
step 5, the model is solved with an optimization solution algorithm to obtain a sparse spectrum and a reconstruction time signal; and
step 6, fault diagnosis is performed by a corresponding component STSA_CI index.

The fault detection method for a rotating machine based on sparse time synchronous averaging is analyzed and described below for the specific implementation of each step.

In step 1, the acquisition of the vibration signal and the rotating frequency or rotating frequency pulse signal of a transmission assembly is the acquisition of rotating speed information and vibration information of the rotating machine. The way to obtain the rotating speed information includes installing various sensors on any shaft of an entire transmission system. The sensor types include an optical encoder sensor, a Hall element sensor, a centrifugal sensor, a tachogenerator, etc. The rotating speed pulse signal obtained from these sensors or the corresponding relationship between the recorded time and the rotating speed is the rotating speed information. The way to obtain the vibration information includes installing various vibration sensors near the concerned components or on the outer casing, including electric, piezoelectric, eddy current and other sensors. Analog-to-digital conversion is performed on the obtained vibration signal and rotating speed signal for further processing. In some other cases, the vibration signal or pulse signal is preprocessed by low-pass, high pass or band-pass filtering. In these cases, the signal is still the vibration signal and pulse signal meeting the requirements of this document. At the same time, in some cases, if the system rotating speed function is known, the method of generating the rotating speed simulation signal in some ways to avoid real-time measurement belongs to the way to obtain the rotating speed information discussed above.

Step 2, according to the type and number of detection components in the rotating machine, a component-aware comb vector g is constructed.

The classification discussion below is primarily for three different kinds of objects and different numbers of cases.

For the case where the detection component is one gear, the component-aware comb vector g of the gear is obtained by the following equation:

$$g = b * {Σ}_{k ∈ {N}^{*}} δ ( n - ⌊ \frac{kM ω}{60 {F}_{s}} ⌋ ) ,$$

wherein M is a sparse representation coefficient length, k represents an order of a frequency component, ω is the rotating speed of the gear, Fₛ is the sampling frequency, └⋅┘ is the rounding operation, N* represents the positive integer set, δ is a function of n, a return value is a Boolean vector, and an expression is as follows:

$$δ ( n - k ) = \{ \begin{matrix}1 , & n = k , n ∈ ℤ ; \\ 0 , & n \neq k , n ∈ ℤ ;\end{matrix}$$

wherein, Σ(⋅) represents a successive logical OR operation, “*” is a convolution operation of the Boolean vector, which is similar to algebraic convolution and is defined as:

y(n)=x(n)*h(n)=Σ_{i=-∞}^{∞}x(i)&h(n−i),
wherein, & is a logical AND operation, b is a sequence of filter passbands and is a Boolean vector with a dimension of h, whose physical meaning is the bandwidth of a filter passband in the sense of the number of data points, the commonly used value of h is a positive integer less than 50, and the preferred expression of b is:

b(n)=1, n∈1, 2, . . . , h;

In some applications, it is often set that the passband width h is greater than the sum of a maximum value of the target frequency fluctuation and an error amount, so as to ensure that the target frequency component is not filtered.

For the case where the detection components are two gears, the component-aware comb vectors g of the gears are obtained by:

$${g}_{c 1} = b * {\sum }_{k ∈ {N}^{*}} δ ( n - ⌊ \frac{kM {ω}_{1}}{60 {F}_{s}} ⌋ ) ,$$

$${g}_{c 2} = b * {\sum }_{k ∈ {N}^{*}} δ ( n - ⌊ \frac{kM {ω}_{2}}{60 {F}_{s}} ⌋ ) ,$$

$$g = {g}_{c 1} \vert {g}_{c 2}$$

wherein ω₁, ω₂ are the rotating speeds of the two concerned gears; g_{c1}, g_{c2} are the component-aware comb vectors of the gear 1 and gear 2, respectively, g is a global component-aware comb vector, “|” is a Boolean logical OR operation; and
for the case where the detection components are three and more gears, the component-aware comb vector g is obtained by the following equation:

$$g = b * {\sum }_{i = 1}^{p} {\sum }_{k ∈ {N}^{*}} δ ( n - ⌊ \frac{kM {ω}_{i}}{60 {F}_{s}} ⌋ ) ,$$

wherein the variable pin the equation is the number of concerned gears and ωᵢ is the rotating speed of each gear.

For the case where the detection component is one rotor, the component-aware comb vector g of the rotor is obtained by the following equation:

$$g = b * {\sum }_{k ∈ {N}^{*}} δ ( n - ⌊ \frac{kM ω}{60 {F}_{s}} ⌋ ) ,$$

wherein, in this equation, ω is the rotating speed of the rotor, k represents an order of a frequency component, M is a sparse representation coefficient length, Fₛ is the sampling frequency, └⋅┘ is the rounding operation, N* represents the positive integer set, δ is a function of n, a return value is a Boolean vector, and an expression is as follows:

$$δ ( n - k ) = \{ \begin{matrix}1 , & n = k , n ∈ ℤ ; \\ 0 , & n \neq k , n ∈ ℤ ;\end{matrix}$$

wherein, Σ(⋅) represents a successive logical OR operation, “*” is a convolution operation of the Boolean vector, which is defined as:

y(n)=x(n)*h(n)=Σ_{i=-∞}^{∞}x(i)&h(n−i),
wherein, & is a logical AND operation, b is a sequence of filter passbands and is a Boolean vector with a dimension of h, whose physical meaning is the bandwidth of a filter passband in the sense of the number of data points, and the expression of b is:

b(n)=1, n∈1, 2, . . . , h;
for the case where the detection components are two rotors, the component-aware comb vectors g of the rotors are obtained by the following equations:

$${g}_{r 1} = b * {\sum }_{k = 1}^{3} δ ( n - ⌊ \frac{kM {ω}_{1}}{60 {F}_{s}} ⌋ ) ,$$

$${g}_{r 2} = b * {\sum }_{k = 1}^{3} δ ( n - ⌊ \frac{kM {ω}_{2}}{60 {F}_{s}} ⌋ ) ,$$

$${g}_{r 3} = b * {\sum }_{l = 1}^{3} {\sum }_{k = 1}^{3} δ ( n - ⌊ \frac{M ( k {ω}_{2} + l {ω}_{1} )}{60 {F}_{s}} ⌋ ) ,$$

$${g}_{r 4} = b * {\sum }_{l = 1}^{3} {\sum }_{k = 1}^{3} δ ( n - ⌊ \frac{M \vert k {ω}_{2} - l {ω}_{1} \vert}{60 {F}_{s}} ⌋ ) ,$$

$$g = {\sum }_{k = 1}^{4} {g}_{i} ,$$

wherein ω₁, ω₂ are the rotating speeds of the two rotors; g₁ represents the component-aware comb vector of the rotating frequency of the rotor 1, g₂ represents the component-aware comb vector of the rotating frequency of the rotor 2, g₃ represents the component-aware comb vector of each of various sum frequencies of the rotor 1 and rotor 2, g₄ represents the component-aware comb vector of each of various difference frequencies of the rotor 1 and rotor 2, and g is a global component-aware comb vector; and
for the case where the detection components are three rotors, the component-aware comb vectors, namely the Boolean vectors g of the rotors are obtained by the following equations:

$${g}_{r 1} = b * {\sum }_{k = 1}^{3} δ ( n - ⌊ \frac{kM {ω}_{1}}{60 {F}_{s}} ⌋ ) ,$$

$${g}_{r 2} = b * {\sum }_{k = 1}^{3} δ ( n - ⌊ \frac{kM {ω}_{2}}{60 {F}_{s}} ⌋ ) ,$$

$${g}_{r 3} = b * {\sum }_{k = 1}^{3} δ ( n - ⌊ \frac{kM {ω}_{3}}{60 {F}_{s}} ⌋ ) ,$$

$$g = {\sum }_{k = 1}^{3} {g}_{rk} ,$$

wherein ω₁, ω₂, ω₃ are the rotating speeds of the three rotors, respectively, and g₁, g₂, g₃ represent the component-aware comb vectors of the rotating frequencies of three rotors, and g is a component-aware comb vector.
for the case where the detection component is a bearing, the component-aware comb vector g of the bearing is obtained by the following equation:

$$g = ∼ ( b * {\sum }_{i = 1}^{p} {\sum }_{k ∈ {N}^{*}} δ ( n - ⌊ \frac{kM {ω}_{i}}{60 {F}_{s}} ⌋ ) ) ,$$

wherein, in this equation, ωᵢ is the rotating speed of the gear or rotor when the signal is introduced with interference, k represents an order of a frequency component, N* represents the positive integer set, p is the total number of the gears or rotors when the signal is introduced with interference, ˜ is a logical NOT operation, M is a sparse representation coefficient length, Fₛ is the sampling frequency, └⋅┘ is the rounding operation, δ is a function of n, a return value is a Boolean vector, and an expression is as follows:

$$δ ( n - k ) = \{ \begin{matrix}1 , & n = k , n ∈ ℤ ; \\ 0 , & n \neq k , n ∈ ℤ ;\end{matrix}$$

wherein, Σ(⋅) represents a successive logical OR operation, “*” is a convolution operation of the Boolean vector, which is defined as:

y(n)=x(n)*h(n)=Σ_{i=-∞}^{∞}x(i)&h(n−i)
wherein, & is a logical AND operation, b is a sequence of filter passbands and is a Boolean vector with a dimension of h, whose physical meaning is the bandwidth of a filter passband in the sense of the number of data points, and the expression of b is:

b(n)=1, n∈1, 2, . . . , h.

Step 3, the quasi-time synchronous average vector w is constructed based on the component-aware comb vector g;

It should be noted that after the component-aware comb vector g is obtained in any case in step 2, the quasi-time synchronous average vector w is generated according to the following steps:

w′(n)=i−ηg
wherein η is a passband amplitude factor, the conventional values of η are real numbers close to but less than 1, and η is multiplied with the component-aware comb vector g to obtain a real number; i is a vector with a dimension of M and all values of 1. In this step, the component-aware comb vector g shaped as a comb filter is changed into a comb notch filter with a value 1−η at the passband.
w=w′(1:M), this step sets the vector dimension to the length of the sparse representation coefficient.

$$w ( \frac{M + 2}{2} : 1 : M ) = w ( \frac{M}{2} : - 1 : 1 )$$

in this step, the comb notch filter is axisymmetric with respect to Fs/2, which accords with the symmetrical property of spectrum in Fourier transform.

In this way, the time synchronous average vector w we finally get is a comb notch filter corresponding to the time synchronous average comb filter, which achieves the same effect as the time synchronous average comb filter after matching with the following model, that is, the frequency component near the passband is kept and the frequency component within the stopband range is removed.

Step 4, the sparse time synchronous averaging model F is constructed by using the quasi-time synchronous average vector w, and the sparse time synchronous averaging model F constructed by the quasi-time synchronous average vector w is as follows:

$$arg {min}_{x} {‖ y - Ax ‖}_{2}^{2} + λ ‖ w ∘ x ‖ ,$$

wherein y is a noise-contained signal to be analyzed, A is a linear transformation operator, such as the DFT, DCT, and other operations, x is a sparse representation coefficient, “∘” is a vector dot product operator, w is the quasi-time synchronous average vector, and λ is a regularization parameter.

When the noise of the signal to be processed is large, the value of λ should be increased; when the noise is small, the value of λ should be appropriately reduced to ensure that the reconstruction signal is closer to the original signal. w is the quasi-time synchronous average vector obtained in step 3, and its function is to make the target frequency component at the passband of the notch filter in the vector less suppressed and the frequency component not at the target frequency more weakened, so as to retain the target frequency and remove the irrelevant frequency component.

Step 5, the model is solved with the optimization solution algorithm to obtain the sparse spectrum and the reconstruction time signal.

It is easy to know that the equation (1) is a convex optimization problem, so the convex optimization algorithm is used to solve the equation (1). When these optimization algorithms are selected, because the convergence result of the convex problem is unique, the iterative optimization algorithm will not affect the convergence result, so theoretically any converging convex optimization method can be used. In some applications, the iterative optimization algorithm selects the Fast Iterative Soft Thresholding Algorithm (FISTA), which is implemented in the following steps:
Step a, an iteration constant μ is set to satisfy 0<μ<1, the initial value of a variable t is 1, an initial sparse representation coefficient x₀ and an intermediate variable z₀ are set to be arbitrary M-dimensional column vectors, a maximum number of loops is set to be Nit in the range of 20<Nit<10000, a loop variable is marked as k, a loop termination constant ε is set, and a feasible value thereof is 10⁻⁶;
Step b, an intermediate variable zₖ is operated using a soft threshold function soft, and w is a quasi-time synchronous average vector w obtained in step 4:

xₖ=soft(zₖ−μA^{T}(Azₖ−y), μwλ),
wherein, the soft threshold function soft is expressed as follows:

$$soft ( x , T ) = x \cdot max ( 1 - \frac{T}{\vert x \vert} , 0 )$$

Step c, the variable tₖ is updated, such that

$${t}_{k + 1} = \frac{1 + \sqrt{1 + 4 {t}_{k}^{2}}}{2} ;$$

Step d, zₖ is updated using the xₖ results of the first two iterations:

$${z}_{k + 1} = {x}_{k} + ( \frac{{t}_{k} - 1}{{t}_{k + 1}} ) ( {x}_{k} - {x}_{k - 1} ) ;$$

and
Step e, the loop variable k is increased by one, if k>Nit or ∥yₖ−Axₖ∥₂²+λ∥w∘xₖ∥−∥yₖ₋₁−Axₖ₋₁∥₂²−λ∥w∘xₖ₋₁∥<ε is satisfied, then \hat{x}=xₖ₋₁, ŷ=A\hat{x}, are set and the loop is exited, otherwise the step b is returned. The final result of the loop is the time domain signal ŷ and the sparse representation coefficient \hat{x} subjected to sparse time domain synchronous averaging.

Step 6, fault diagnosis is performed according to the corresponding component STSA_CI index.

There are three different STSA_CI index design strategies based on ŷ and \hat{x} for the gear, rotor and bearing.

The STSA_CI index is composed of the following indices for a gear fault:
a root-mean-square value STSA_RMS:

$$STSA\_RMS = \sqrt{\frac{1}{N} {\sum }_{n = 1}^{N} {\hat{y}}^{2} ( n )} ,$$

wherein ŷ represents a time domain signal subjected to sparse time domain synchronous averaging, and N is the signal length;
a crest factor STSA_CF:

$$STSA\_CF = \frac{{\hat{y}}_{max}}{STSA\_RMS} ;$$

a kurtosis index STSA_KurV:

$$STSA\_KurV = \frac{N {{\sum }_{n = 1}^{N} [ \hat{y} ( n ) - \overline{y} ]}^{4}}{\{ {{\sum }_{n = 1}^{N} [ \hat{y} ( n ) - \overline{y} ]}^{2} \}} ;$$

the kurtosis index is sensitive to impulse faults, especially when the faults occur early, the kurtosis index increases significantly. However, when the index value increases to a certain extent, it will decline with the increase of faults. The kurtosis index is sensitive to early faults, but its stability is not good. The RMS has no obvious change in the early faults of gear or bearing, while the peak factor is the ratio of the peak value of the signal to the root mean square value. The increase of the signal peak value will cause the peak factor value to become larger. The peak factor is usually used to detect the change of the signal mode caused by impact vibration sources (such as gear damage or bearing outer ring);
an engaging frequency amplitude STSA_OMX:

STSA_OMXᵢⱼ=Aᵢⱼ;
wherein Aᵢⱼ represents the amplitude of the j-th-order engaging frequency of the i-th gear in the sparse representation coefficient \hat{x} obtained in step 5;
a feature frequency magnitude STSA_FQ:

STSA_FQᵢ=Σⱼ₌₁³Aᵢⱼ
wherein Aᵢⱼ represents the amplitude of the j-th-order fault feature frequency of the i-th gear in the envelope spectrum φ, while the envelope spectrum is obtained by the following steps:

h={square root over (\hat{y}²+(H(ŷ))²)},

φ= [symbol] (h),
wherein H(⋅) represents the Hilbert transform, [symbol] (⋅) represents the discrete Fourier transform; and
an envelope kurtosis index STSA_NB4:

$$STSA\_NB 4 = \frac{N {\sum }_{n = 1}^{N} {( {h}_{l} ( n ) - {\overline{h}}_{l} )}^{4}}{{\{ \frac{1}{L} {\sum }_{l = 1}^{L} [ {\sum }_{n = 1}^{N} {( {h}_{l} ( n ) - {\overline{h}}_{l} )}^{2} ] \}}^{2}} ;$$

wherein h̅ is the average of the envelope h of the time signal ŷ subjected to sparse time synchronous averaging, l represents the number of segments of the present data record in the multi-segment data record, and L is the total number of segments of the data record.

The engaging frequency amplitude is often dominant in the gear signal, and the engaging frequency amplitude will be significantly enhanced when faults occur. The feature frequency amplitude obtained from the envelope spectrum and the envelope kurtosis index more directly reflect the size of the modulation component generated by the fault impulse.

For a rotor fault, the STSA_CI index is composed of the following indices:

A rotating frequency amplitude STSA_AR, in the equation, A_{R}_{ᵢⱼ} represents the amplitude of the j-th multiple frequency of the i-th rotor in the sparse representation coefficient \hat{x} subjected to sparse time domain synchronous averaging:

STSA_AR=A_{R}_{ᵢⱼ};
a root-mean-square value STSA_RMS, the formula has the same form as the index with the same name above;
3) an average amplitude STSA_MA:

$$STSA\_MA = \frac{1}{N} {\sum }_{n = 1}^{N} \vert \hat{y} ( n ) \vert ;$$

and
4) a square root amplitude STSA_RA:

$$STSA\_RA = {[ \frac{1}{N} {\sum }_{n = 1}^{N} \sqrt{\vert \hat{y} ( n ) \vert} ]}^{2} .$$

For a bearing fault, the STSA_CI index is composed of the following indices:
1) a feature frequency magnitude STSA_FQ:

STSA_FQᵢ=Σⱼ₌₁³Aᵢⱼ,
wherein Aᵢⱼ represents the amplitude of the j-th-order frequency of the i-th bearing fault feature frequency in the envelope spectrum φ, while the envelope spectrum is obtained by:

h={square root over (\hat{y}²+(H(ŷ))²)}

φ= [symbol] (h)
wherein ŷ is a time signal subjected to sparse time domain synchronous averaging, H(⋅) represents the Hilbert transform, and [symbol] (⋅) represents the discrete Fourier transform;
2) a crest factor STSA_CF:

$$STSA\_CF = \frac{{\hat{y}}_{max}}{\sqrt{\frac{1}{N} {\sum }_{n = 1}^{N} {\hat{y}}^{2} ( n )}} ,$$

wherein N is the signal length; and
3) a kurtosis STSA_KurV, and the formula has the same form as the index with the same name in claim 8.

### Embodiment 1: Gear Fault Detection

Embodiment 1 relates to fault diagnosis of a gear transmission system, which can be realized by MATLAB. The experimental object is an SQI gear fault simulation test bench. An input shaft of the bench is connected with a sun gear at the left end, and reaches a right parallel wheel reducer after two-stages of planetary reducers, and then reaches a right output shaft after parallel wheel deceleration for two times. The test bench also includes a bearing load and a programmable magnetic brake. During the experiment, the simulation experiment is carried out by replacing different normal components and faulty components. The encoder for measuring the motor rotating speed built in the test bench is used to output a pulse signal. In the experiment, the rotating frequency of the motor is set to be close to 30 Hz, and the sampling frequency is set to 20480 Hz. The collected signals include a broken tooth fault signal and a normal gear vibration signal. Four channels of vibration signals and one channel of time-scale signals are collected each time, and the sensor for collecting the time-scale signals is located on the input shaft. The data storage format is txt, and each data collection time is 3 minutes.

The two groups of signals are processed by intercepting the signals with the number of data points being N=2¹⁹ under stable working conditions. The sparse representation coefficient length M is set to satisfy M=2N=2²⁰. Since the detection component is one gear, the component-aware comb vector g can be obtained by applying the formula

$$g = b * {\sum }_{k ∈ {N}^{*}} δ ( n - ⌊ \frac{kM ω}{60 {F}_{s}} ⌋ )$$

in step 2. In the formula, ω is set to be the rotating speed of the gear, and the passband bandwidth is set to 3, that is, the length of the filter passband sequence b is 3. Then the time synchronous average vector w is obtained by the formula in step 3:

w′(n)=i−ηg

$$w = {w}^{′} ( 1 : M ) \\ w ( \frac{M + 2}{2} : 1 : M ) = w ( \frac{M}{2} : - 1 : 1 )$$

a passband amplitude factor η is set to be η=1−10⁻⁶.
the sparse time synchronous averaging model F is constructed by using the quasi-time synchronous average vector w:

$$arg {min}_{x} {‖ y - Ax ‖}_{2}^{2} + λ ‖ w ∘ x ‖$$

wherein, the Fourier transform is used as a linear transformation operator A, a regularization parameter λ is set to be equal to 40, and then a maximum number of iterations Nit is set to be equal to 200, a loop termination constant ε is set to be equal to 10⁻⁵, next, iteration is performed according to step 5 to finally obtain a sparse representation coefficient \hat{x} of a frequency domain and a time waveform ŷ.

Please also refer to the time domain and frequency domain comparison of the faulty gear signal before and after the sparse time synchronous averaging processing. It can be seen from the comparison between the original frequency spectrum of the fault signal and the sparse frequency spectrum obtained through the sparse time synchronous averaging processing that the irrelevant frequency components in the signal obtained from the original vibration signal processed by the method provided by the disclosure are obviously suppressed, and the gear fault features such as the sideband are more obvious. By observing the time waveform 2d of the reconstruction signal subjected to sparse time synchronous averaging, it can be seen that there are obvious periodic impact components in the reconstructed time waveform, which also strongly proves the ability of the algorithm to extract the fault features.

Please also refer to the time domain and frequency domain comparison of the normal and fault-free gear signals before and after sparse time synchronous averaging processing. It can be found that in the sparse frequency spectrum processed by the algorithm of the disclosure, the gear rotating frequency component and the sidebands on both sides of the engaging frequency are weak, and there is no obvious fault impact component in the observed time waveform, which is compared with the faulty gear signal group, thus proving the correctness of the algorithm.

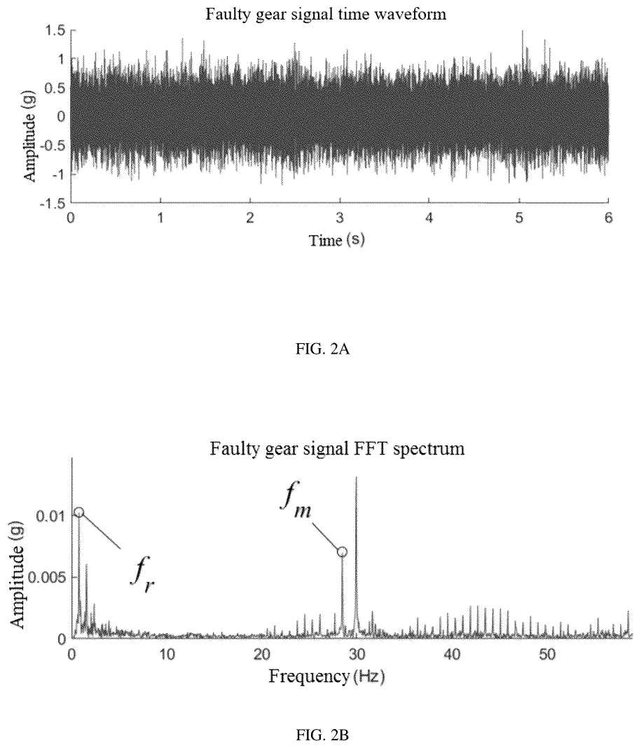

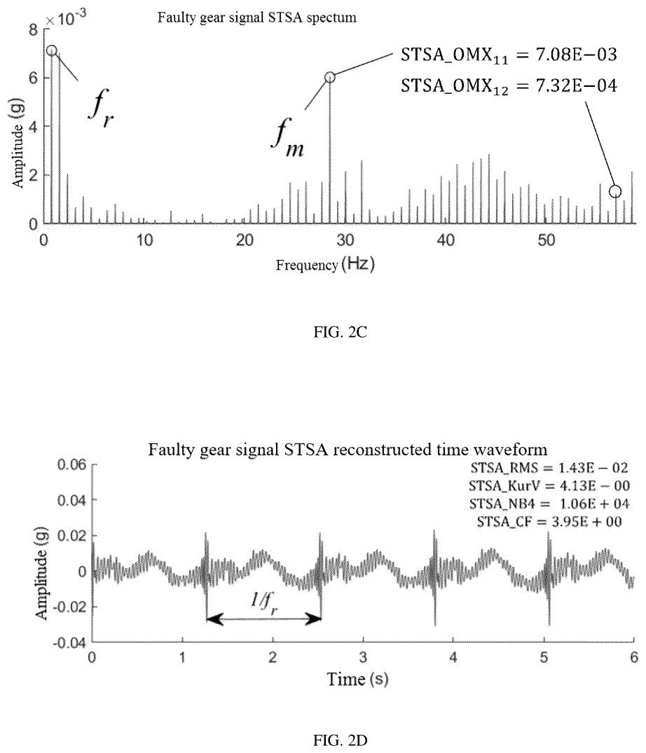

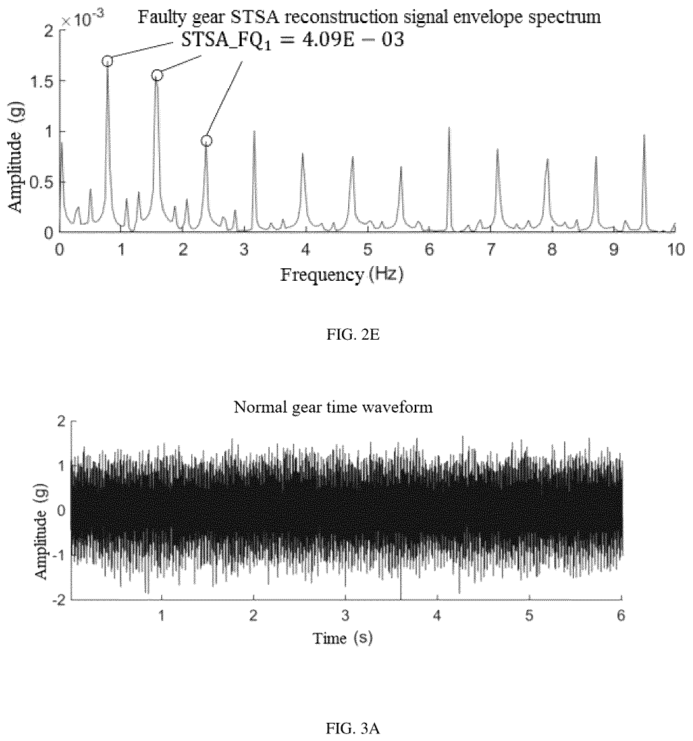

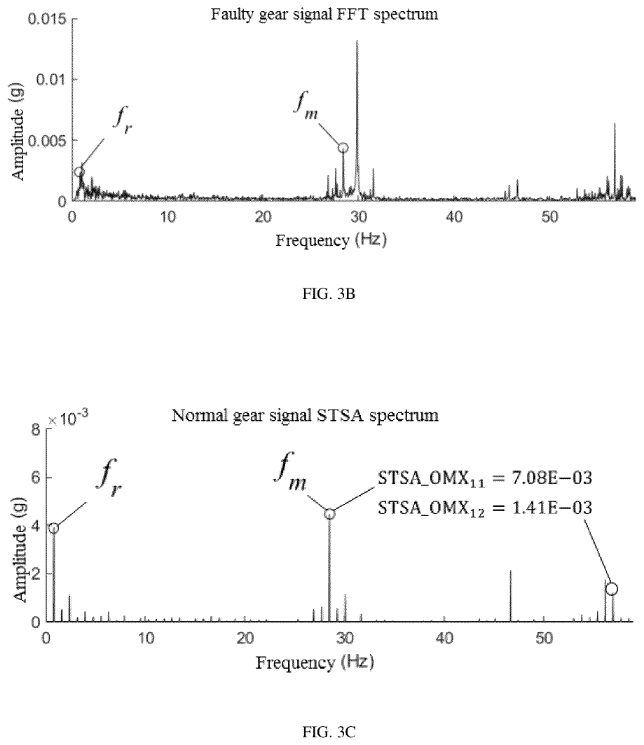

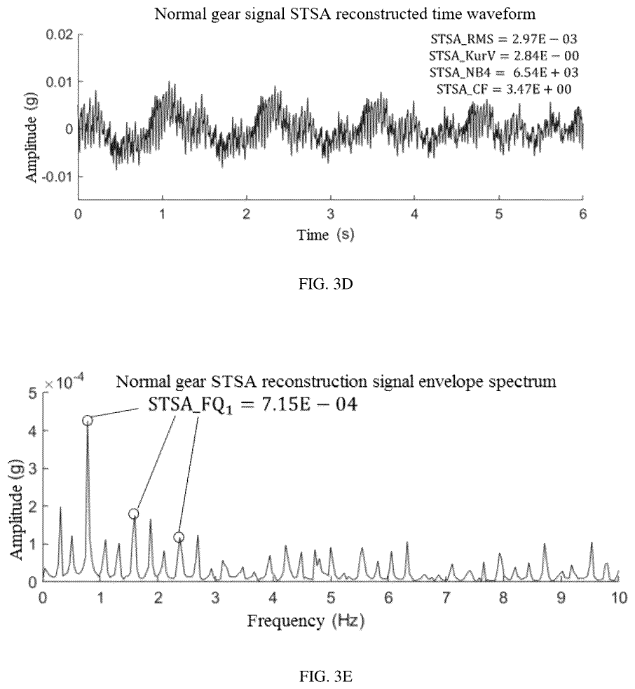

The STSA_CI index is calculated based on the above method, the statistical index calculated based on the time waveform includes an STSA_RMS, an STSA_KurV, an STSA_NB4 and an STSA_CF, all of which are calculated based on the reconstructed time waveform obtained after the sparse TSA calculation in FIGS. 2d and 3d. The engaging frequency amplitude STSA_OMX is obtained from the sparse TSA spectrum in FIGS. 2c and 3c, and the fault feature frequency amplitude STSA_FQ is obtained from the envelope spectrum of the reconstructed time waveform after the sparse TSA calculation in FIGS. 2e and 3e.

Please refer to Table 1, which is the STSA_CI index comparison results of two groups of gear signals, it can be seen that each index of the fault signal is significantly higher than that of a normal gear signal, so it shows the rationality of the STSA_CI index and the effectiveness of the sparse time synchronous averaging diagnosis method proposed in the disclosure in gear fault diagnosis.

TABLE 1

| Index name | Faulty gear signal | Normal gear signal |
|---|---|---|
| STSA_RMS | 1.43E−02 | 2.97E−03 |
| STSA_OMX1 | 7.08E−03 | 1.93E−03 |
| STSA_OMX2 | 7.32E−04 | 1.41E−03 |
| STSA_FQ | 4.09E−03 | 7.15E−04 |
| STSA_CF | 3.95E+00 | 3.47E+00 |
| STSA_KurV | 4.13E+00 | 2.84E+00 |
| STSA_NB4 | 1.06E+04 | 6.54E+03 |

### Embodiment 2: Rotor Fault Detection

Embodiment 2 relates to the diagnosis of an engine rotor rub-impact fault, which can be realized by MATLAB. The diagnosis object is a high and low pressure rotor of an aero-engine. A certain type of aero-engine numbered M2 leaves the factory after assembly, and its vibration exceeds the limit threshold during acceptance test. During the test, the vibration signals of a front fulcrum, a middle fulcrum and a rear fulcrum are collected. In the test, the engine is first warmed up, and then increased to a high-pressure rotating speed of about 11400 r/min. After running at this speed for more than 4 minutes, the peak value of vibration at the rear fulcrum exceeds the limit value, and the engine slows down. The engine of the same model numbered M3 has also experienced the processes of warming up, speeding up and slowing down, and its model and working conditions are similar to those of M2. In this disclosure, the aero-engine rotor fault is analyzed by using the vibration signal of the rear fulcrum when the rotating speeds of M3 and M2 are similar:
the data sampling frequency is 3000 Hz, and the stable working condition signals with the high voltage rotating speed close to 11400 r/min in normal and faulty rotor data are intercepted, and the signals with a duration of 10 s are intercepted for processing every time. A sparse representation coefficient length M is set to satisfy M=2N=60000, since the detection components are two rotors, the component-aware comb vectors of the gear components can be obtained by applying the formula in step 2 as follows:

$${g}_{r 1} = b * {\sum }_{k = 1}^{3} δ ( n - ⌊ \frac{kM {ω}_{1}}{60 {F}_{s}} ⌋ ) \\ {g}_{r 2} = b * {\sum }_{k = 1}^{3} δ ( n - ⌊ \frac{kM {ω}_{2}}{60 {F}_{s}} ⌋ ) \\ {g}_{r 3} = b * {\sum }_{l = 1}^{3} {\sum }_{k = 1}^{3} δ ( n - ⌊ \frac{M ( k {ω}_{2} + l {ω}_{1} )}{60 {F}_{s}} ⌋ ) \\ {g}_{r 4} = b * {\sum }_{l = 1}^{3} {\sum }_{k = 1}^{3} δ ( n - ⌊ \frac{M \vert k {ω}_{2} - l {ω}_{1} \vert}{60 {F}_{s}} ⌋ ) \\ g = {\sum }_{k = 1}^{4} {g}_{rk}$$

wherein ω₁, ω₂ are the rotating speeds of the high-pressure rotor and the low-pressure rotor; g₁ represents the component-aware comb vector of the rotating frequency of the low-pressure rotor, g₂ represents the component-aware comb vector of the rotating frequency of the high-pressure rotor, g₃ represents the component-aware comb vector of each of various sum frequencies of high-pressure rotor and the low-pressure rotor, g₄ represents the component-aware comb vector of each of various difference frequencies of the high-pressure rotor and the low-pressure rotor, g is a quasi-component-aware comb vector, and the passband bandwidth is set to 3, that is, the length of points of the filter passband sequence b is 3. Then the time synchronous average vector w is obtained by the formula in step 3:

$${w}^{′} ( n ) = i - η g \\ w = {w}^{′} ( 1 : M ) \\ w ( \frac{M + 2}{2} : 1 : M ) = w ( \frac{M}{2} : - 1 : 1 )$$

a passband amplitude factor η is set to be η=1−10⁻⁶.
the sparse time synchronous averaging model F is constructed by using the quasi-time synchronous average vector w:

$$arg {min}_{x} {‖ y - Ax ‖}_{2}^{2} + λ ‖ w ∘ x ‖$$

wherein, the Fourier transform is used as a linear transformation operator A, a regularization parameter λ is set to be equal to 40, and then a maximum number of iterations Nit is set to be equal to 200, a loop termination constant ε is set to be equal to 10⁻⁵, next, iteration is performed according to step 5 to finally obtain a sparse representation coefficient \hat{x} of a frequency domain and a time waveform ŷ.

Please refer to the original waveform of the normal rotor vibration signal, the Fourier transform spectrum and the sparse spectrum of the normal rotor vibration signal subjected to sparse time synchronous averaging. fₗ in the figure represents the low-pressure rotor rotating frequency and fₕ represents the high-pressure rotor rotating frequency. From the FFT spectrum of the normal signal, it can be seen that the signal energy is mainly concentrated in the rotating frequency of the high-pressure rotor, while the energy in the low-voltage rotating frequency is low. From the sparse spectrum, it can be seen that each order of rotating frequencies of the high-pressure rotor and the low-pressure rotor is retained, while other irrelevant frequency components and noise are filtered out. The high voltage rotating frequency component is dominant, and the amplitude is basically consistent with the original FFT.

Please also refer to the original waveform of the faulty rotor vibration signal, the Fourier transform spectrum and the sparse spectrum of the faulty rotor vibration signal subjected to sparse time synchronous averaging. From the FFT spectrum, it can be seen that the high-pressure rotor rotating frequency is still the signal component with the highest energy, and compared with the normal signal, the amplitude of the high-pressure rotating frequency is larger, and the energy ratio is larger than other components. The fault signal is subjected to sparse time synchronous averaging similar to the normal signal processing, and the comparison between the sparse spectrum obtained and the sparse spectrum of the normal signal can clearly see that the energy of the high-pressure rotor frequency component in the fault signal is greater.

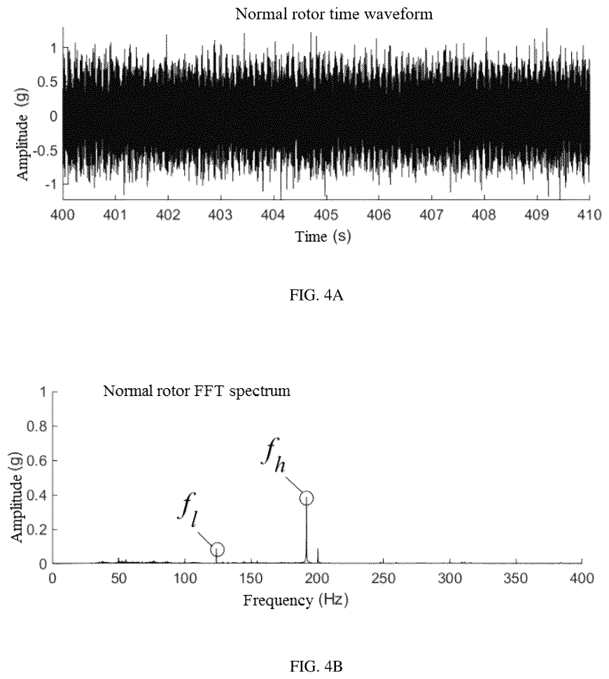

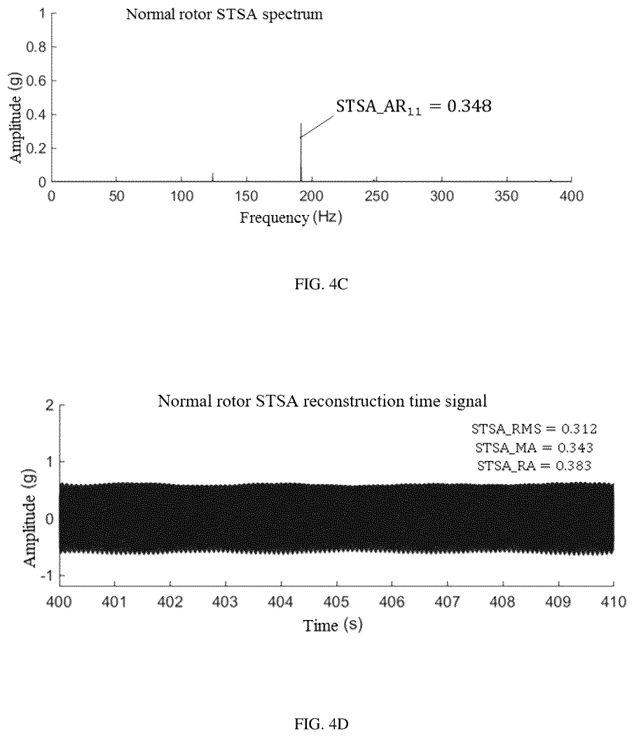

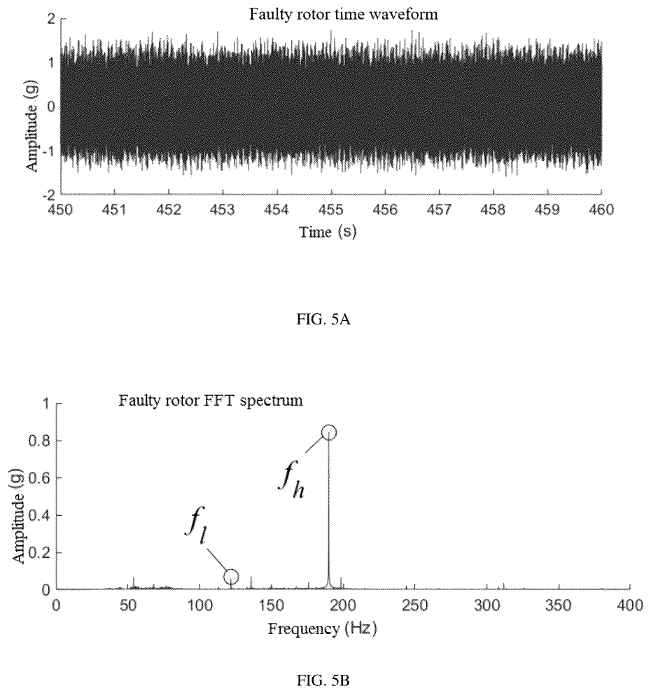

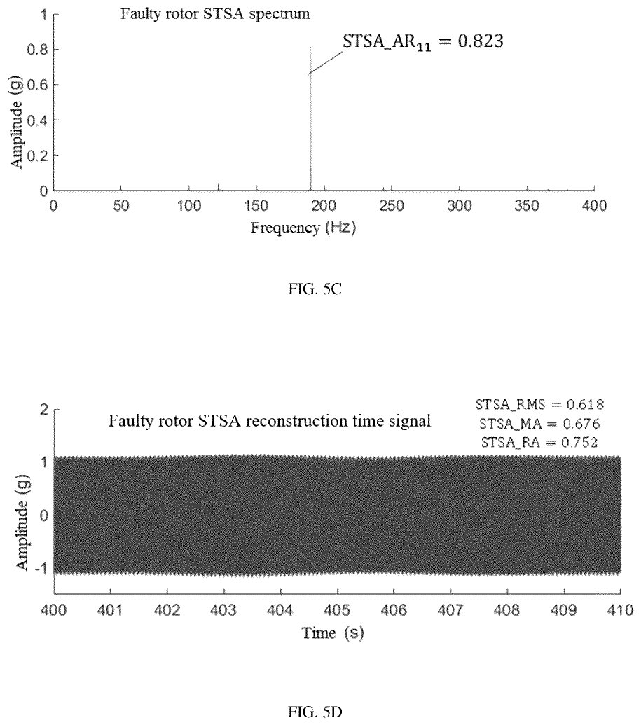

According to the time signal ŷ obtained by processing the normal and fault signals respectively by the method proposed in the disclosure, the STSA_CI index is calculated based on the above method, the statistical index calculated based on the time waveform includes an STSA_RMS, an STSA_MA, and an STSA_RA, all of which are calculated based on the reconstructed time waveform obtained after the sparse TSA calculation in FIGS. 4d and 5d. The rotating frequency amplitude STSA_AR is obtained from the sparse TSA spectrum in FIGS. 4c and 5c, and please refer to the following table for the results. It can be seen that each index of the fault signal is significantly higher than that of the normal rotor signal, which shows that the STSA_CI index is reasonable and the sparse time synchronous averaging diagnosis method proposed in the disclosure is effective in rotor fault diagnosis.

TABLE 2

| Index name | Faulty rotor signal | Normal rotor signal |
|---|---|---|
| STSA_AR11 | 0.823 | 0.348 |
| STSA_RA | 0.752 | 0.383 |
| STSA_RMS | 0.618 | 0.312 |
| STSA_MA | 0.676 | 0.343 |

### Embodiment 3: Bearing Fault Detection

Embodiment 3 relates to the fault diagnosis of an intermediate bearing of a dual-rotor aero-engine, and the core algorithm is realized by MATLAB. The diagnosis object is the intermediate bearing of the dual-rotor aero-engine fault simulation test bench. The test bench simulates the dual-rotor structure of the aero-engine, in which the high and low-pressure rotors are driven by magnetoelectric motors respectively, and the GTF gearbox on the left side is driven by the low-pressure rotor. The preset fault is the 0.4 mm scratch on the inner ring of the intermediate bearing. Both the fault group and the experimental group are under the constant working conditions of the high-pressure rotating speed of 12000 rpm and the low-pressure rotating speed of 7000 rpm. The theoretical fault feature frequency of of the intermediate bearing is 647.19 Hz, the sampling frequency of the vibration signal is 20480 Hz, and the low-pass filtered signal with the interception time of 10 s is processed. The sparse representation coefficient length M is set to satisfy M=2N=409600. Since the detection component is the bearing, the component-aware comb vector g can be obtained by applying the formula

$$g = b * {Σ}_{k ∈ {N}^{*}} δ ( n - ⌊ \frac{k M ω}{60 {F}_{s}} ⌋ )$$

in step 2. In the formula, ωᵢ is set to be the rotating speeds of the high and low-pressure rotors, and the passband bandwidth is set to 45, that is, the length of the filter passband sequence b is 45. Then the time synchronous average vector w is obtained by the formula in step 3:

$${w}^{′} ( n ) = i - η g$$

$$w = {w}^{′} ( 1 : M )$$

$$w ( \frac{M + 2}{2} : 1 : M ) = w ( \frac{M}{2} : - 1 : 1 )$$

a passband amplitude factor η is set to be η=1−10⁻⁶.
the sparse time synchronous averaging model F is constructed by using the quasi-time synchronous average vector w:

$$arg {min}_{x} {‖ y - Ax ‖}_{2}^{2} + λ ‖ w ∘ x ‖$$

wherein, the Fourier transform is used as a linear transformation operator A, a regularization parameter λ is set to be equal to 400, and then a maximum number of iterations Nit is set to be equal to 200, a loop termination constant ε is set to be equal to 10⁻⁵, next, iteration is performed according to step 5 to finally obtain a sparse representation coefficient \hat{x} of a frequency domain and a time waveform ŷ.

Please refer to the original waveform of the fault bearing signal, the FFT spectrum, the sparse spectrum after the sparse time synchronous averaging processing and the envelope spectrum of its reconstructed time signal. From the FFT spectrum, the obvious high and low-pressure rotating frequency components can be seen. The rotor rotating frequency and its multiple frequency are all interference frequency components independent of bearing fault features. The high-pressure rotating frequency of 200.4 Hz and the low-pressure rotor double-rotating frequency of 233.4 Hz are higher, which is not conducive to the reflection of the bearing fault impact frequency in the envelope spectrum. In the sparse frequency spectrum after the sparse time synchronous averaging processing, it can be seen that the frequencies of the above high and low-pressure rotors are filtered out a lot, and the modulation component of 648 Hz can be seen at 1500 Hz-5000 Hz, which is close to the theoretical fault feature frequency of the intermediate bearing, which is 647.19 Hz. From the envelope spectrum of the reconstructed time signal, the fault feature frequency of the intermediate bearing at 648.7 Hz can also be seen.

Please refer to the original waveform of the normal bearing signal, the FFT spectrum, the sparse spectrum after the sparse time synchronous averaging processing and the envelope spectrum of its reconstructed time signal. Like the fault signal, from the FFT spectrum, the high and low-pressure rotor rotating frequency components can be seen, in which the high-pressure one-fold rotating frequency 200.7 Hz and three-fold rotating frequency 601.9 Hz are higher in terms of amplitude. In the sparse frequency spectrum after the sparse time synchronous averaging processing, it can be seen that the frequencies of the above high and low-pressure rotors are largely filtered out, but compared with the fault signal, there is no bearing fault impact component in the sparse frequency spectrum obtained by this method, and there is no bearing fault feature frequency in the reconstruction signal envelope spectrum.

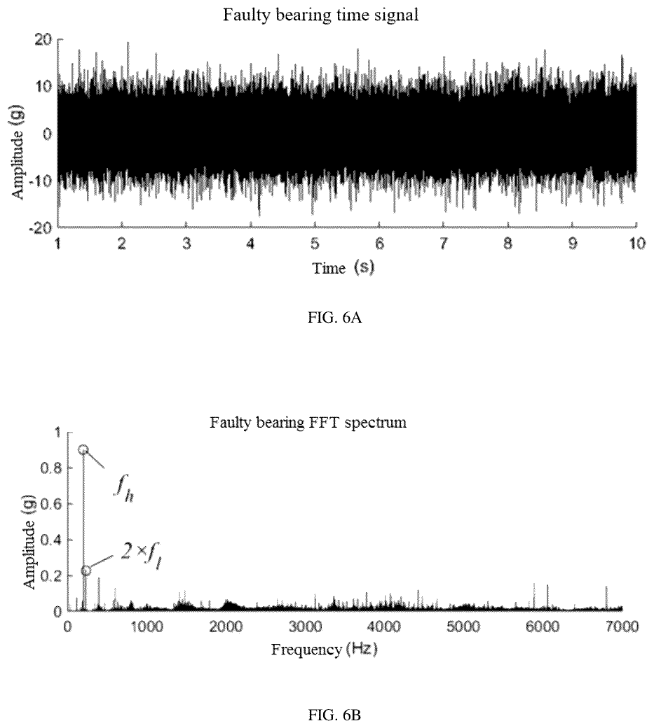

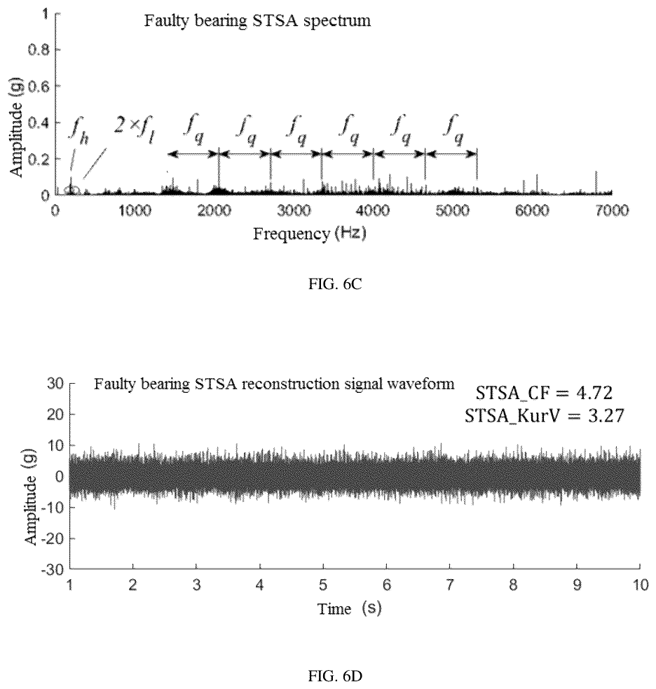

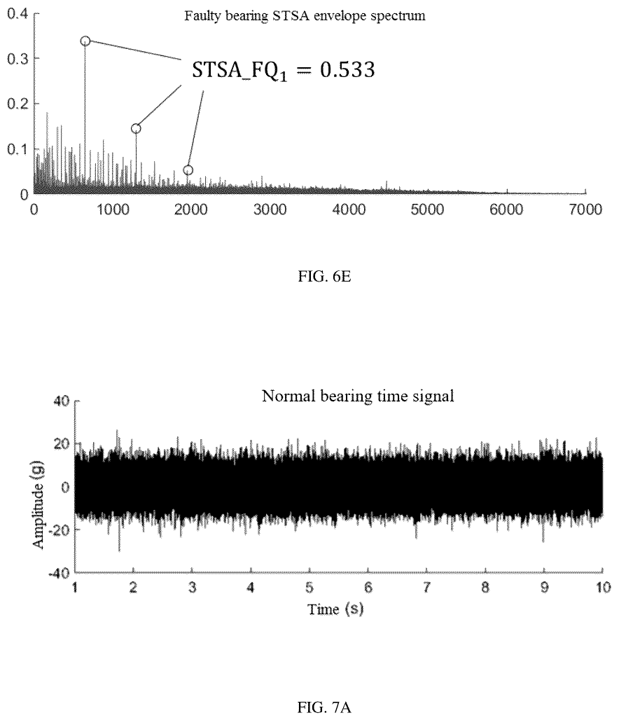

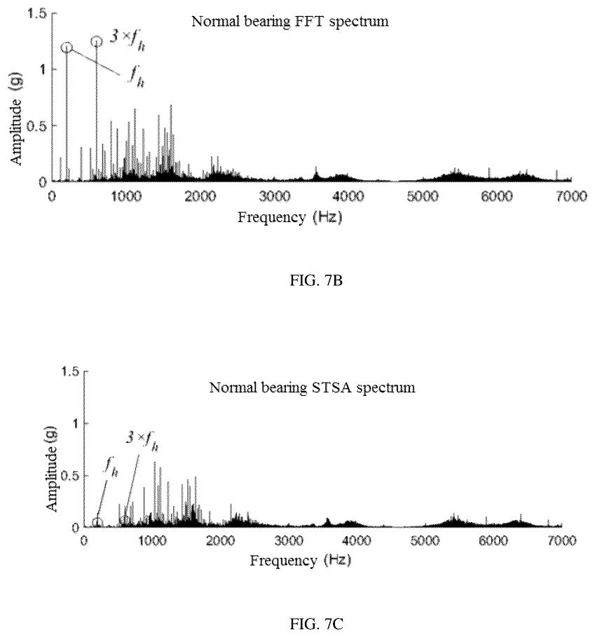

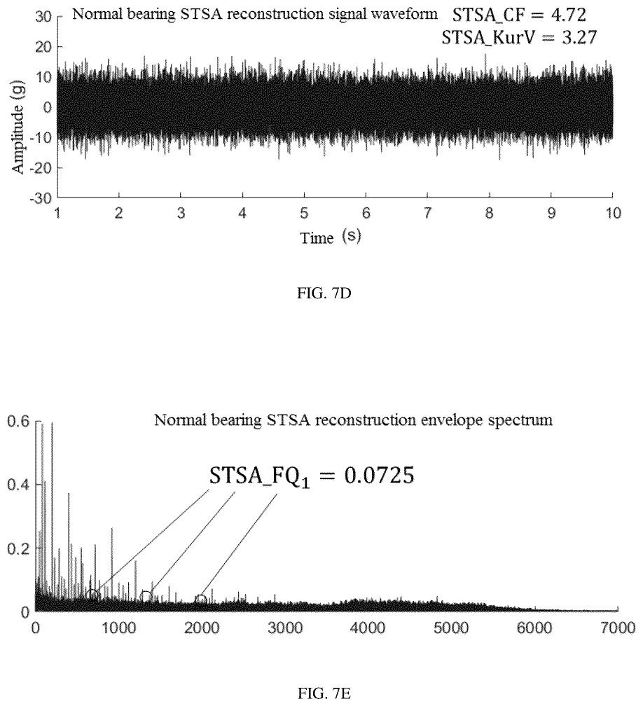

Then, the STSA_CI index is calculated based on the above method, the statistical index calculated based on the time waveform includes an STSA_CF and an STSA_KurV, all of which are calculated based on the reconstructed time waveform obtained after the sparse TSA calculation in FIGS. 6d and 7d. The fault feature frequency amplitude STSA_FQ is obtained from the envelope spectrum of the reconstructed time domain waveform obtained after the sparse TSA calculation in FIGS. 6e and 7e, and please refer to the following table for the results. It can be seen that each index of the fault signal is significantly higher than that of the normal signal, which shows that the STSA_CI index is reasonable and the sparse time synchronous averaging diagnosis method proposed in the disclosure is effective in bearing fault diagnosis.

TABLE 3

| Index name | Faulty bearing signal | Normal bearing signal |
|---|---|---|
| STSA_FQ | 0.533 | 0.0725 |
| STSA_CF | 5.82 | 4.72 |
| STSA_KurV | 3.80 | 3.27 |

While the embodiments of the disclosure have been described above in conjunction with the accompanying drawings, the disclosure is not limited to the above-described specific embodiments and fields of application, the above-described specific embodiments are merely illustrative, instructive and not limiting. Those of ordinary skill in the art, with reference to this specification and without departing from the scope of the claims of the present disclosure, may also take many forms, all of which fall within the protection of the present disclosure.

What is claimed is:

1. A fault detection method for a rotating machine based on sparse time synchronous averaging, comprising the following steps:
S100, collecting a vibration signal and a rotating frequency or rotating frequency pulse signal of the rotating machine and performing analog-to-digital conversion to obtain the vibration signal and rotating speed information by a sensor;
S200, according to the type and number of detection components in the rotating machine, constructing a component-aware comb vector g based on the vibration signal and rotating speed information, wherein the type includes the gear, rotor and bearing;
S300, constructing a quasi-time synchronous average vector w based on the component-aware comb vector g;
S400, constructing a sparse time synchronous averaging model F by using the quasi-time synchronous average vector w;
S500, solving the sparse time synchronous averaging model F with an optimization solution algorithm to obtain a sparse spectrum and a reconstruction time signal; and
S600, constructing an STSA_CI index according to the sparse spectrum and time signal for fault diagnosis, wherein, for a gear fault, the STSA_CI index comprises a root mean square value STSA_RMS, a crest factor STSA_CF, a kurtosis index STSA_KurV, an engaging frequency amplitude STSA_OMX, a feature frequency amplitude STSA_FQ and an envelope kurtosis index STSA_NB4; for a rotor fault, the STSA_CI index comprises a rotating frequency amplitude STSA_AR, a root mean square value STSA_RMS, an average amplitude STSA_MA and a square root amplitude STSA_RA, and for a bearing fault, the STSA_CI index comprises a feature frequency amplitude STSA_FQ, a crest factor STSA_CF or a kurtosis index STSA_KurV.

2. The fault detection method for a rotating machine based on sparse time synchronous averaging according to claim 1, wherein, preferably,
in S200, 1) for the case where the detection component is one gear, the component-aware comb vector g of the gear is obtained by the following equation:
$$g = b * {Σ}_{k ∈ {N}^{*}} δ ( n - ⌊ \frac{k M ω}{60 {F}_{s}} ⌋ ) ,$$
wherein M is a sparse representation coefficient length, k represents an order of a frequency component, ω is the rotating speed of the gear, Fₛ is the sampling frequency, └⋅┘ is the rounding operation, N* represents the positive integer set, δ is a function of n, a return value is a Boolean vector, and an expression is as follows:
$$δ ( n - k ) = \{ \begin{matrix}1 , & n = k , n ∈ ℤ ; \\ 0 , & n \neq k , n ∈ ℤ\end{matrix} ;$$
wherein, Σ(⋅) represents a successive logical OR operation, [symbol] represents an integer, “*” is a convolution operation of the Boolean vector, which is defined as:
y(n)=x(n)*h(n)=Σ_{i=-∞}^{∞}x(i)&h(n−i),
wherein, & is a logical AND operation, b is a sequence of filter passbands and is a Boolean vector with a dimension of h, whose physical meaning is the bandwidth of a filter passband in the sense of the number of data points, and the expression of b is:
b(n)=1, n∈1, 2, . . . , h;
2) for the case where the detection components are two gears, the component-aware comb vectors g of the gears are obtained by:
$${g}_{c 1} = b * {Σ}_{k ∈ {N}^{*}} δ ( n - ⌊ \frac{kM {ω}_{1}}{60 {F}_{s}} ⌋ ) ,$$
$${g}_{c 2} = b * {Σ}_{k ∈ {N}^{*}} δ ( n - ⌊ \frac{kM {ω}_{2}}{60 {F}_{s}} ⌋ ) ,$$
$$g = {g}_{c 1} \vert {g}_{c 2} ,$$
wherein ω₁, ω₂ are the rotating speeds of the two gears; g_{c1}, g_{c2} are the component-aware comb vectors of the gear 1 and gear 2, respectively, g is a global component-aware comb vector, “|” is a Boolean logical OR operation; and
3) for the case where the detection components are three and more gears, the component-aware comb vector g is obtained by the following equation:
$$g = b * {\sum }_{i = 1}^{p} {Σ}_{k ∈ {N}^{*}} δ ( n - ⌊ \frac{kM ω}{60 {F}_{s}} ⌋ ) ,$$
wherein the variable p in the equation is the number of concerned gears and ωᵢ is the rotating speed of each gear.

3. The fault detection method for a rotating machine based on sparse time synchronous averaging according to claim 1, wherein, in S200, 1) for the case where the detection component is one rotor, the component-aware comb vector g of the rotor is obtained by the following equation:
$$g = b * {Σ}_{k ∈ {N}^{*}} δ ( n - ⌊ \frac{k M ω}{60 {F}_{s}} ⌋ ) ,$$
wherein, in this equation, ω is the rotating speed of the rotor, k represents an order of a frequency component, M is a sparse representation coefficient length, Fₛ is the sampling frequency, └⋅┘ is the rounding operation, N* represents the positive integer set, δ is a function of n, a return value is a Boolean vector, and an expression is as follows:
$$δ ( n - k ) = \{ \begin{matrix}1 , & n = k , n ∈ ℤ ; \\ 0 , & n \neq k , n ∈ ℤ\end{matrix} ;$$
wherein, Σ(⋅) represents a successive logical OR operation, [symbol] represents an integer, “*” is a convolution operation of the Boolean vector, which is defined as:
y(n)=x(n)*h(n)=Σ_{i=-∞}^{∞}x(i)&h(n−i),
wherein, & is a logical AND operation, b is a sequence of filter passbands and is a Boolean vector with a dimension of h, whose physical meaning is the bandwidth of a filter passband in the sense of the number of data points, and the expression of b is:
b(n)=1, n∈1, 2, . . . , h;
2) for the case where the detection components are two rotors, the component-aware comb vectors g of the rotors are obtained by the following equations:
$${g}_{r 1} = b * {\sum }_{k = 1}^{3} δ ( n - ⌊ \frac{kM {ω}_{1}}{60 {F}_{s}} ⌋ ) ,$$
$${g}_{r 2} = b * {\sum }_{k = 1}^{3} δ ( n - ⌊ \frac{kM {ω}_{2}}{60 {F}_{s}} ⌋ ) ,$$
$${g}_{r 3} = b * {\sum }_{l = 1}^{3} {\sum }_{k = 1}^{3} δ ( n - ⌊ \frac{M ( k {ω}_{2} + l {ω}_{1} )}{60 {F}_{s}} ⌋ ) ,$$
$${g}_{r 4} = b * {\sum }_{l = 1}^{3} {\sum }_{k = 1}^{3} δ ( n - ⌊ \frac{M \vert k {ω}_{2} + l {ω}_{1} \vert}{60 {F}_{s}} ⌋ ) ,$$
$$g = {\sum }_{k = 1}^{4} {g}_{rk} ,$$
wherein ω₁, ω₂ are the rotating speeds of the two rotors; gᵣ₁ represents the component-aware comb vector of the rotating frequency of the rotor 1, gᵣ₂ represents the component-aware comb vector of the rotating frequency of the rotor 2, gᵣ₃ represents the component-aware comb vector of each of various sum frequencies of the rotor 1 and rotor 2, gᵣ₄ represents the component-aware comb vector of each of various difference frequencies of the rotor 1 and rotor 2, and g is a global component-aware comb vector; and
3) for the case where the detection components are three rotors, the component-aware comb vectors g of the rotors are obtained by the following equations:
$${g}_{r 1} = b * {\sum }_{k = 1}^{3} δ ( n - ⌊ \frac{kM {ω}_{1}}{60 {F}_{s}} ⌋ ) ,$$
$${g}_{r 2} = b * {\sum }_{k = 1}^{3} δ ( n - ⌊ \frac{kM {ω}_{2}}{60 {F}_{s}} ⌋ ) ,$$
$${g}_{r 2} = b * {\sum }_{k = 1}^{3} δ ( n - ⌊ \frac{kM {ω}_{3}}{60 {F}_{s}} ⌋ ) ,$$
$$g = {\sum }_{k = 1}^{3} {g}_{rk} ,$$
wherein ω₁, ω₂, ω₃ are the rotating speeds of the three rotors, respectively, and gᵣ₁, gᵣ₂, gᵣ₃ represent the component-aware comb vectors of the 3 rotors, and g is a global component-aware comb vector.

4. The fault detection method for a rotating machine based on sparse time synchronous averaging according to claim 1, wherein, in S200, for the case where the detection component is a bearing, the component-aware comb vector g of the bearing is obtained by the following equation:
$$g = ∼ ( b * {Σ}_{i = 1}^{p} {Σ}_{k ∈ {N}^{*}} δ ( n - ⌊ \frac{k M {ω}_{i}}{60 {F}_{s}} ⌋ ) ) ,$$
wherein, in this equation, ωᵢ is the rotating speed of the gear or rotor when the signal is introduced with interference, k represents an order of a frequency component, N* represents the positive integer set, p is the total number of the gears or rotors when the signal is introduced with interference, ˜ is a logical NOT operation, M is a sparse representation coefficient length, Fₛ is the sampling frequency, └⋅┘ is the rounding operation, δ is a function of n, a return value is a Boolean vector, and an expression is as follows:
$$δ ( n - k ) = \{ \begin{matrix}1 , & n = k , n ∈ ℤ ; \\ 0 , & n \neq k , n ∈ ℤ\end{matrix} ;$$
wherein, Σ(⋅) represents a successive logical OR operation, “*” is a convolution operation of the Boolean vector, which is defined as:
$$y ( n ) = x ( n ) * h ( n ) = {\sum }_{i = - ∞}^{∞} x ( i ) \& h ( n - i )$$
wherein, & is a logical AND operation, b is a sequence of filter passbands and is a Boolean vector with a dimension of h, whose physical meaning is the bandwidth of a filter passband in the sense of the number of data points, and the expression of b is:
b(n)=1, n∈1, 2, . . . , h.

5. The fault detection method for a rotating machine based on sparse time synchronous averaging according to claim 1, wherein, in S300, the component-aware comb vector g generates the quasi-time synchronous average vector w according to the following steps:
w′(n)=i−ηg,
w=w′(1:M),
wherein w′ is a quasi-time synchronous average vector distributed over an entire positive integer domain, and w′ is truncated to obtain a quasi-time synchronous average vector w of the length A, η is a passband amplitude factor, which is multiplied with the component-aware comb vector g to obtain a real number; i is a vector with a dimension of M and all values of 1, M is the sparse representation coefficient length; and
it is noted that although p [symbol] ω and w appeared above have different definitions and forms in different algorithm application objects, their mathematical meanings and dimensions are the same when they are applied to a sparse model. For the sake of simplicity, the disclosure no longer distinguishes the different forms of these variables in each application object of the algorithm.

6. The fault detection method for a rotating machine based on sparse time synchronous averaging according to claim 5, wherein, in S400, constructing the sparse time synchronous averaging model F by using the quasi-time synchronous average vector w is as follows:
$$arg {min}_{x} {‖ y - Ax ‖}_{2}^{2} + λ ‖ w ∘ x ‖ ,$$
wherein y is a noise-contained signal to be analyzed, A is a linear transformation operator, x is a sparse representation coefficient, “∘” is a vector dot product operator, λ is a regularization parameter, w is the quasi-time synchronous average vector, and when the linear transformation operator A is the Fourier transform, it is required to perform an axisymmetric operation on w:
$$w ( \frac{M + 2}{2} : 1 : M ) = w ( \frac{M}{2} : - 1 : 1 ) .$$

7. The fault detection method for a rotating machine based on sparse time synchronous averaging according to claim 6, wherein, S500 comprises,
S501, first, performing following iterative steps on the sparse time synchronous averaging model, setting an iteration constant μ to satisfy 0<μ<1, setting an initial sparse representation coefficient x₀ and an iterative intermediate variable z₀ to be arbitrary M-dimensional column vectors, setting a maximum number of loops to be Nit in the range of 20<Nit<10000, marking a loop variable as k, setting a loop termination constant ε to be 10⁻⁶; and taking an initial value t₀ of an iteration variable tₖ as 1;
S502, operating an intermediate variable zₖ using a soft threshold function soft,
xₖ=soft(zₖ−μA^{T}(Azₖ−y), μwλ),
wherein, the soft threshold function soft is expressed as follows:
$$soft ( x , T ) = x \cdot max ( 1 - \frac{T}{\vert x \vert} , 0 ) ,$$
A is a linear transformation operator, w is a quasi-time synchronous average vector, and λ is a regularization parameter;
S503, updating the variable tₖ, such that
$${t}_{k + 1} = \frac{1 + \sqrt{1 + 4 {t}_{k}^{2}}}{2} ;$$
S504, updating zₖ using the xₖ results of the first two iterations:
$${z}_{k + 1} = {x}_{k} + ( \frac{{t}_{k} - 1}{{t}_{k + 1}} ) ( {x}_{k} - {x}_{k - 1} ) ;$$
and
S505, increasing the loop variable k by one, if k>Nit or ∥yₖ−Axₖ∥₂²+λ∥w∘xₖ∥−∥yₖ₋₁−Axₖ₋₁∥₂²−λ∥w∘xₖ₋₁∥<ε is satisfied, then setting
\hat{x}=xₖ₋₁, ŷ=A\hat{x},
to obtain a time signal ŷ and a sparse representation coefficient \hat{x} subjected to sparse time synchronous averaging, and exiting the loop, otherwise returning to S502.

8. The fault detection method for a rotating machine based on sparse time synchronous averaging according to claim 7, wherein the STSA_CI index is composed of the following indices for a gear fault:
1) a root-mean-square value STSA_RMS:
$$STSA\_RMS = \sqrt{\frac{1}{N} {\sum }_{n = 1}^{N} {\hat{y}}^{2} ( n )} ,$$
wherein ŷ represents a time signal subjected to sparse time synchronous averaging, and N is the signal length;
2) a crest factor STSA_CF:
$$STSA\_CF = \frac{{\hat{y}}_{max}}{STSA\_RMS} ;$$
wherein ŷₘₐₓ is the maximum absolute value of in a ŷ sequence, and is calculated by the method of loop traversal,
3) a kurtosis index STSA_KurV:
$$STSA\_KurV = \frac{N {{\sum }_{n = 1}^{N} [ \hat{y} ( n ) - \overline{y} ]}^{4}}{{\{ {{\sum }_{n = 1}^{N} [ \hat{y} ( n ) - \overline{y} ]}^{2} \}}^{2}} ;$$
wherein y̅ is the average value of the ŷ sequence,
4) an engaging frequency amplitude STSA_OMX:
STSA_OMXᵢⱼ=Aᵢⱼ;
wherein Aᵢⱼ represents the amplitude of the j-th-order engaging frequency of the i-th gear in the sparse representation coefficient \hat{x} subjected to sparse time synchronous averaging,
5) a feature frequency magnitude STSA_FQ:
$${STSA\_FQ}_{i} = {\sum }_{j = 1}^{3} {B}_{ij}$$
wherein Bᵢⱼ represents the amplitude of the j-th-order fault feature frequency of the i-th gear in the envelope spectrum φ, while the envelope spectrum is obtained by the following steps:
h={square root over (\hat{y}²+(H(ŷ))²)},
φ= [symbol] (h),
wherein H(⋅) represents the Hilbert transform, [symbol] (⋅) represents the discrete Fourier transform; and
6) an envelope kurtosis index STSA_NB4:
$$STSA\_NB4 = \frac{N {\sum }_{n = 1}^{N} {( {h}_{l} ( n ) - {\overline{h}}_{l} )}^{4}}{{\{ \frac{1}{L} {\sum }_{l = 1}^{L} [ {\sum }_{n = 1}^{N} {( {h}_{l} ( n ) - {\overline{h}}_{l} )}^{2} ] \}}^{2}} ;$$
wherein l represents the number of segments of the present data record in the multi-segment data record, L is the total number of segments of the data record, hₗ is the envelope of the time signal of the l-th data subjected to sparse time synchronous averaging, and h̅ₗ is the average of hₗ.

9. The fault detection method for a rotating machine based on sparse time synchronous averaging according to claim 7, wherein the STSA_CI index is composed of the following indices for a gear fault and a rotor fault:
1) a rotating frequency amplitude STSA_AR, in the equation, A_{R}_{ᵢⱼ} represents the amplitude of the j-th multiple frequency of the i-th rotor in the sparse representation coefficient \hat{x} subjected to sparse time synchronous averaging:
STSA_AR=A_{R}_{ᵢⱼ};
2) a root-mean-square value STSA_RMS:
$$STSA\_RMS = \sqrt{\frac{1}{N} {\sum }_{n = 1}^{N} {\hat{y}}^{2} ( n )} ,$$
wherein ŷ represents a time signal subjected to sparse time synchronous averaging, and N is the signal length;
3) an average amplitude STSA_MA:
$$STSA\_MA = \frac{1}{N} {\sum }_{n = 1}^{N} \vert \hat{y} ( n ) \vert ;$$
and
4) a square root amplitude STSA_RA:
$$STSA\_RA = {[ \frac{1}{N} {\sum }_{n = 1}^{N} \sqrt{\vert \hat{y} ( n ) \vert} ]}^{2} .$$

10. The fault detection method for a rotating machine based on sparse time synchronous averaging according to claim 7, wherein the STSA_CI index is composed of the following indices for a bearing fault:
1) a feature frequency magnitude STSA_FQ:
STSA_FQᵢ=Σⱼ₌₁³Aᵢⱼ,
wherein Aᵢⱼ represents the amplitude of the j-th-order frequency of the i-th bearing fault feature frequency in the envelope spectrum φ, while the envelope spectrum is obtained by:
h={square root over (\hat{y}²+(H(ŷ))²)}
φ= [symbol] (h)
wherein ŷ is a time signal subjected to sparse time synchronous averaging, H(⋅) represents the Hilbert transform, and [symbol] (⋅) represents the discrete Fourier transform;
2) a crest factor STSA_CF:
$$STSA\_CF = \frac{{\hat{y}}_{max}}{\sqrt{\frac{1}{N} {\sum }_{n = 1}^{N} {\hat{y}}^{2} ( n )}} ,$$
wherein N is the signal length; and
3) a kurtosis STSA_KurV:
$$STSA\_KurV = \frac{N {{\sum }_{n = 1}^{N} [ \hat{y} ( n ) - \overline{y} ]}^{4}}{{\{ {{\sum }_{n = 1}^{N} [ \hat{y} ( n ) - \overline{y} ]}^{2} \}}^{2}} .$$
